(19) United States
(12) Patent Application Publication
(10) Pub. No.: US 2014/0021183 A1
(43) Pub. Date: Jan. 23, 2014

(54) METHOD AND SYSTEM FOR GAS METAL ARC WELDING AND A CONTACT TIP USED FOR THE SAME

(71) Applicant: Steven R. Peters, Huntsburg, OH (US)

(72) Inventor: Steven R. Peters, Huntsburg, OH (US)

(73) Assignee: LINCOLN GLOBAL INC., City of Industry, CA (US)

(21) Appl. No.: 13/553,538

(22) Filed: Jul. 19, 2012

(51) Int. Cl. B23K 9/00; B23K 9/10; B23K 9/28; B23K 9/09

(52) U.S. Cl. 219/130.51; 219/130.1

(57) ABSTRACT

A method and system with a welding torch having a contact tip which has an upper portion and a lower portion, where the upper portion and the lower portion are electrically isolated from each other and each of the upper portion and the lower portion make contact with the same electrode during a welding operation. A first power supply is coupled to the upper portion which provides a first current to the upper portion during the welding operation, and a second power supply is coupled to the second portion which provides a second current during the welding operation. The first and second currents are accumulated in the electrode during welding to provide a welding waveform. The first power supply can have a higher inductance than the second power supply.

### TECHNICAL FIELD

The subject invention generally relates to devices, systems and methods for welding. More specifically, embodiments of the present invention can be used for Metal Inert Gas (MIG), Pulsed Gas Metal Arc Welding (GMAW-P) or any type of pulsed spray metal transfer. More particularly, certain embodiments relate to a torch and particular waveforms for use in such types of welding.

### BACKGROUND

Welding machines and systems use welding waveforms having low background currents and higher peak currents in pulses. Often, the magnitude of the low level background currents is limited to the extent in which the arc formed by the low level background current can be maintained and stabilized. Furthermore, the welding machines and systems are designed such that they have a very low inductance in the machine for delivery of the welding current. This low inductance allows the welding machine to change the current very quickly in response to events, such as shorting events, or otherwise be very responsive. As an example, a GMAW-P process and known GMAW-P machines are shown and described in The Lincoln Electric Company Publication, NX-2.70 entitled, “Process: Pulsed Spray Metal Transfer” (August 2004), which is incorporated by reference in its entirety. For such known welding machines, using standard welding torches with a standard stick out length, the background current is often limited to a minimum of about 20 amps, which can be disadvantageous due to the amount of heat it can add to the weld.

Therefore, there remains a need for welding systems that can reduce the magnitude of the low level background current below those previously known.

### SUMMARY

Embodiments of the present invention comprise a system and method for metal transfer, a welding torch is provided having a contact tip which has an upper portion and a lower portion, where the upper portion and the lower portion are electrically isolated from each other and each of the upper portion and the lower portion make contact with the same electrode during a welding operation. A first power supply is coupled to the upper portion which provides a first current to the upper portion during the welding operation, and a second power supply is coupled to the second portion which provides a second current during the welding operation. The first and second currents are accumulated in the electrode during welding to provide a welding waveform.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1. is a schematic illustration of one embodiment of a welding system of the present invention;

FIG. 2 is an illustrative embodiment of a welding torch for use in the system of FIG. 1;

FIG. 3 is a partial cross-sectional view of one embodiment of the welding torch of FIG. 2;

FIGS. 4 to 4B depict cross-sectional views of exemplary embodiments of welding contact tip portions for use in the welding torch of FIG. 2;

FIGS. 5A to 5E are graphical depictions of welding waveforms for use with embodiments of the present invention; and

FIG. 6 is a graphical illustration of another welding waveform to be used with embodiments of the present invention.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

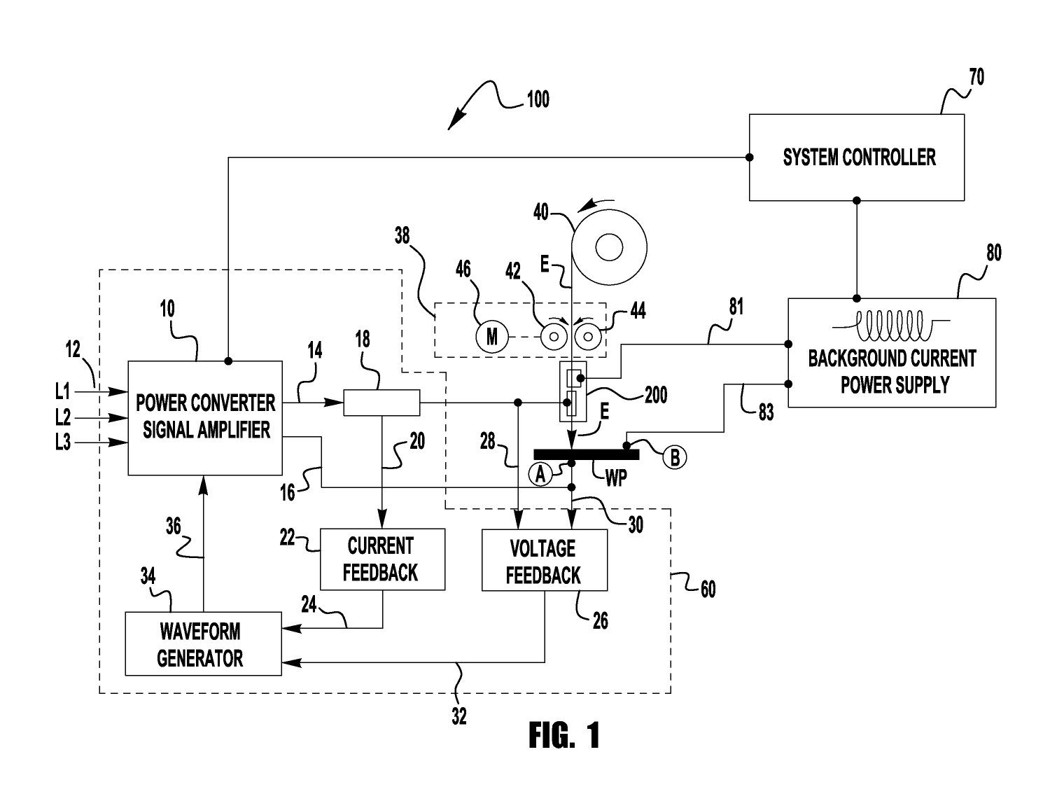

FIG. 1. shows an electric arc welding system 100 in accordance with an exemplary embodiment of the present invention. The system 100 includes a power supply 60, which is capable of generating a plurality of current pulses and direct those current pulses to an electrode E as it is advanced towards a workpiece WP. An exemplary embodiment of the power supply 60 includes a power source 10, which may be for example, a high switching speed power source, such as an inverter or chopper, with an input power supply 12 illustrated as a three phase electrical input. Of course, a single phase input power supply having various voltages and frequencies or even a motor or engine driven generator or alternator could be used to direct electrical power to converter or power source 10. Output leads 14, 16 are connected in series across the electrode E and workpiece WP to perform a welding process, such as for example a GMAW-P process, by directing an appropriate current waveform (for example, pulses) to the electrode and workpiece. Although only one pair of output leads 14, 16 are shown, multiple pair of output leads may be provided for selective delivery of one or more segments of the welding waveform. In one embodiment of subject system and method, the welding electrode E is a continuous wire which may be a flux cored wire; but in the alternative, a solid wire may be used. Accordingly, the welding wire electrode E may be self-shielding or instead may use an external shielding, for example, from an external shielding gas or flux blanket. To the extent any shielding may be used, the shielding gas/flux supply is directed into the welding operation between the electrode and workpiece in accordance with standard practice.

In an exemplary embodiment, the power source 10 delivers a welding current defined by a plurality of pulses to the electrode wire E for use in a welding operation between the electrode E and a workpiece W. Accordingly, the welding current is sufficient to form a welding arc between the tip of the welding wire electrode E and the workpiece W during the pulses. The welding arc may be defined by an arc current and/or arc voltage. In an exemplary embodiment, a shunt, LEM or equivalent components/circuit 18 determines the arc current by creating a signal in line 20 directed to feedback circuit 22 so that the output signal on line 24 is a digital or analog representation of the actual output current at any given time. In a like manner, voltage feedback circuit 26 has inputs 28, 30 for sensing the instantaneous arc voltage of the welding operation to create a signal in output 32. This voltage signal is a digital or analog representation of the instantaneous arc voltage. The arc current and voltage are directed in a feedback loop to waveform generator 34 which generator is set to create a series of current waveforms or pulses with a selected profile, in accordance with a signal in control line 36. The control signal represents the desired welding current. Output control signal in line 36 is either in the form of digital instructions, a program statement or an analog command signal in accordance with waveform processing. In one particular embodiment of waveform process for welding, the control of the power source 10 using a waveform generator 34 is in accordance with Waveform Control Technology™, an electronic waveform control system and method from The Lincoln Electric Company of Cleveland, Ohio. Alternatively or in addition to, the control signal in line 36 may be generated by standard waveform process technology known in the art, for example, as described in U.S. Pat. No. 7,173,214. The power source 10 includes a controller, which may be embodied as a pulse width modulator circuit, normally a software signal, which circuit controls the waveforms in the welding process between electrode E and workpiece WP. In general, the power supply 60 can be constructed similarly to known welding power supplies which are capable of performing pulse welding operations, such as MIG, GMAW-P, spray arc transfer, surface tension transfer (STT), or other similar pulse welding operations. An example of such a welding power supply is the Power Wave®, manufactured by The Lincoln Electric Company of Cleveland, Ohio.

Welding electrode wire E is shown schematically in FIG. 1 as being fed by a feeding mechanism 38. In one exemplary embodiment of the feeding mechanism 38 the electrode wire E is pulled from a spool 40 between drive rolls 42, 44 which are rotated by motor 46. The electrode wire E may be fed through a flexible conduit or sleeve 48 into a welding torch or gun 200 used either in an automatic, semi-automatic or manual welding process. The welding torch 200 is used to direct electrical current from the power source 10 to the wire electrode E. The construction of the welding torch 200, and more specifically its contact tip, will be discussed further below.

As also shown in FIG. 1, the system includes an additional power supply 80. The power supply 80 is a background current power supply 80 which provides a background current to the electrode E during welding. In the exemplary embodiment shown, the background current is also supplied to the electrode E via the torch 200. The background power supply is coupled to the torch 200 via the lead 81 and the workpiece WP via the lead 83. It is noted that the power supply 80 can also include components such as voltage feedback 26, current feedback 22, shunt 18 and waveform generator 34, as power supply 60, but these components have been omitted for clarity of the figure. Furthermore, the background current supply 80 can be similarly constructed to common welding power supplies which are capable of supplying a current, voltage and/or power to a welding electrode during welding.

In exemplary embodiments of the present invention, during welding the power supply 60 provides a plurality of current pulses to the electrode E as it is being advanced to the workpiece WP and the power supply 80 is providing a generally constant current, which can be referred to as a background current in some embodiments. These two current signals (from power supplies 60 and 80) are coupled together in the electrode to form a single welding waveform—which is generally similar to traditional welding waveforms. The advantages of this will be discussed further below.

In known welding systems, a single power supply provides both the pulses and background current to an electrode during welding. This is generally done to reduced costs and complexity by having a single power supply. However, this is not without its disadvantages. To perform high performance or complex pulse welding operations, today's welding power supplies have a very low inductance level in the welding circuit. This is to ensure that the welding current is extremely responsive to changes made in the current during welding. For example, when pulse welding it is desirable to be able to ramp the current up and down as quickly as possible, such as when transitioning from a low background current to a higher peak current. However, this low inductance can be problematic during the background portion of a welding current waveform. During the background period (for example, between pulses) the background current is at a relatively low level (compared to the pulses) and the low inductance of the welding system may allow the arc to become unstable and “pop out”. Systems have been built in an effort to address this instability, such as the Pulse Power 500, manufactured by The Lincoln Electric Co., of Cleveland, Ohio. However, improvements for this issue remain desirable. This instability comes from the fact that the current level is relatively low and the welding system does not have the system inductance to easily overcome the fluctuations that occur in the background current at such low levels. To overcome this instability it is generally required that the background current be kept at a current level to ensure arc stability. In many cases the background current must be at least 20 amps and in some welding operations must be as high as 50 amps. However, these current levels can add unwanted, additional heat into the weld joint. Therefore, if possible it is desirable to make the background current as low as possible, but yet keep the arc stable during the background period. Embodiments of the present invention are easily capable of achieving these benefits.

In exemplary embodiments of the present invention, the pulse power supply 60 has a low inductance level, which is consistent with common welding power supplies. For example, the power supply 60 has an inductance—for the output welding circuit (that is, the output circuit in the power supply 60 which is used to output the current to the electrode E)—in the range of 40 to 70 micro henries with a saturation current in the range of 20 to 50 amps. However, the background current power supply 80 has a higher inductance level—for its output welding circuit—than the power supply 60. In an exemplary embodiment, the inductance level for the welding circuit of the power supply 80 is in the range of 15 to 80 milli henries with a saturation current in the range of 20 to 50 amps. In a further exemplary embodiment, the inductance is no more than 100 milli henries with a saturation current in the range of 20 to 50 amps. Of course, these ranges are for exemplary embodiments of the present invention, and other systems may have different values and still operate within the spirit and scope of the present invention. By having this increased inductance in the welding circuit the power supply 80 is capable of providing a more stable arc between the electrode E and the workpiece WP at low current levels. The inductance will allow the arc to be stably maintained during the fluctuations and anomalies that can occur at low current levels. It is noted that the output welding circuit for the power supply 80 can be constructed similar to that for the power supply 60, or can be similar to known types of current output circuits, but is constructed to have a higher inductance level as stated above. This can be accomplished in various ways, for example, including an inductor (or similar components) to achieve the desired inductance level.

Thus, in exemplary embodiments of the present invention the welding waveform used to weld the workpiece W is a resultant waveform from the combination of the current from the power supply 60 and the background current power supply 80. This will be discussed further below.

Also, as shown in FIG. 1, in exemplary the power supply is coupled to the workpiece at point A and the power supply 80 is coupled at point B, which is remote and distinct from point A.

As shown in FIG. 1, the system 100 further includes a system controller 70 which is coupled to each of the power supplies 60 and 80, and can also be coupled to the wire feeder 38. The system controller 70 can be any computerized device which is capable of communicated with and/or controlling the power supplies and wire feeder. Further, although shown as a separate component, the controller 70 can be integral to any of the power supplies. The controller 70 is utilized to ensure proper communication between the power supplies 60/80 as needed and can be used to control the operation of the power supplies 60/80 and the system 100. For example, the controller 70 can be utilized to control the output current of any one, or both, of the power supplies to provide the desired welding current/waveform. For example, the controller 70 can control the magnitude and polarity of the background current from the power supply 80 and/or control the frequency, magnitude, duration, polarity etc. of current pulse from the power supply 60.

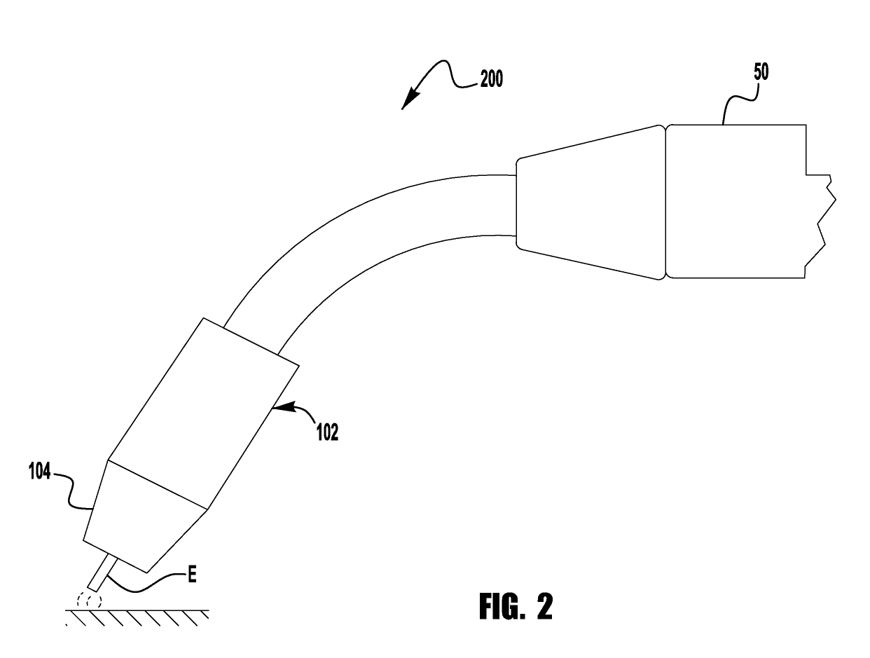

FIG. 2 illustrates an exemplary embodiment of a welding gun/torch 200 for use of in embodiments of the system 100. The gun 200 can be constructed similar to any known or commonly used welding guns or torches used for welding operations such as MIG, GMAW-P, etc. In the exemplary embodiment shown, the conduit 48 is joined by connector 50 to the wire feeding mechanism 38 so that the feed rolls 42, 44 can feed the electrode to the gun/torch 200. The gun/torch can be assembled onto a robot, automatic or semiautomatic hand held torch. The welding torch 200 includes an outer housing 102, which is shown in this particular embodiment, with an inwardly tapered portion 104. It should be noted that for purposes of the present description the terms “gun” and “torch” are intended to be synonymous and not distinguished from each other, but are merely terms used to describe the device/apparatus used to deliver the electrode E to the workpiece WP at the welding operation.

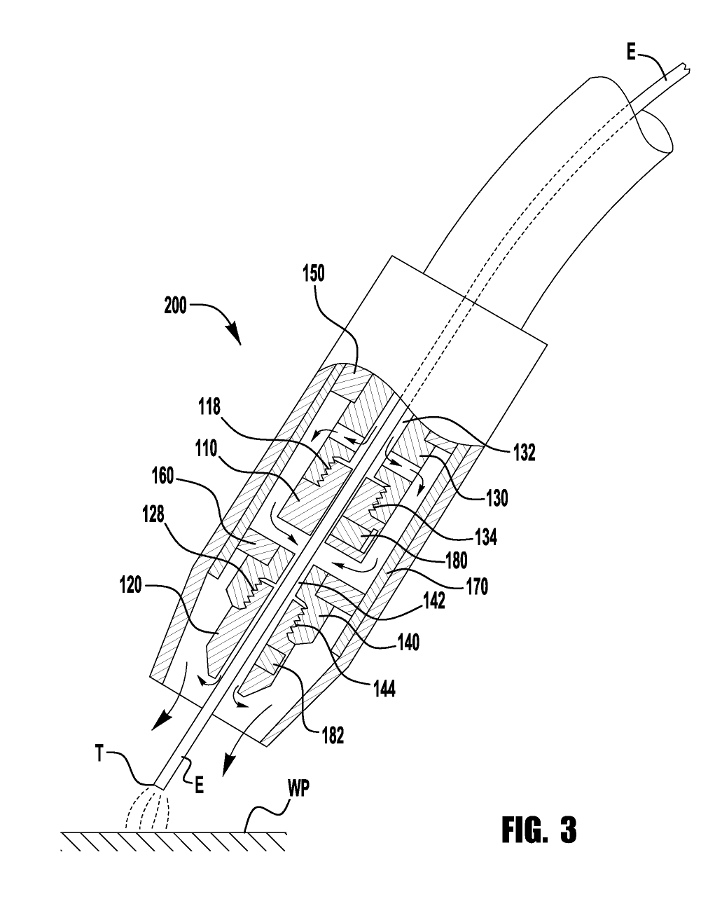

FIG. 3 depicts a more detailed view of an exemplary embodiment of the torch/gun 200 of the present invention. In general, the torch/gun 200 has a construction similar to that of known devices, except that in exemplary embodiments of the present invention, rather than utilizing a single contact tip in the gun/torch 200 the torch 200 has multiple axially aligned contact tip portions 110 and 120 which are electrically isolated from each other in the gun 200. In exemplary embodiments of the present invention, one of the contact tip portions is coupled to the pulse power supply 60 while the other contact tip portion is coupled to the background power supply 80. In the embodiments shown and discussed herein the upper contact tip portion 110 (that is, the portion furthest from the workpiece WP during welding) is coupled to the background power supply 80 and the lower portion 120 is coupled to the other power supply 60. Therefore, during welding the upper portion 110 provides a first portion of the welding waveform used to welding the workpiece and the lower portion 120 provides a second portion of the waveform used to conduct the welding operation. That is, the two respective currents from the power supplies 60/80 are combined into the electrode E to form a single welding waveform. As stated above, the contact tip portions 110 and 120 are electrically isolated from each other such that the respective currents passed through the portions are provided to the electrode E and the currents are not combined through contact between the contact tip portions. As further discussed below, embodiments of the present invention allow for the optimization of stick-out length for each of the respective contact tip portions 110/120 to optimize the welding operation. Accordingly, based upon the arrangement of the contact tip portions, different portions of the welding waveform can be applied at a desired “stick out length,” i.e., the distance between the distal end of the contact tip portion and the top of the arc.

In the exemplary embodiment shown in FIG. 3, the torch 200 includes a first welding contact tip portion 110 and a second welding contact tip portion 120 spaced axially from the first welding contact tip portion 110. As shown, the portions 110/120 are in line with each other to allow the electrode E to pass through both of the contact tips portions. The general construction and configuration of the torch 200 and tip portions 110/120 can be optimized based on a desired structure and welding operation and is not limited to the embodiments depicted herein.

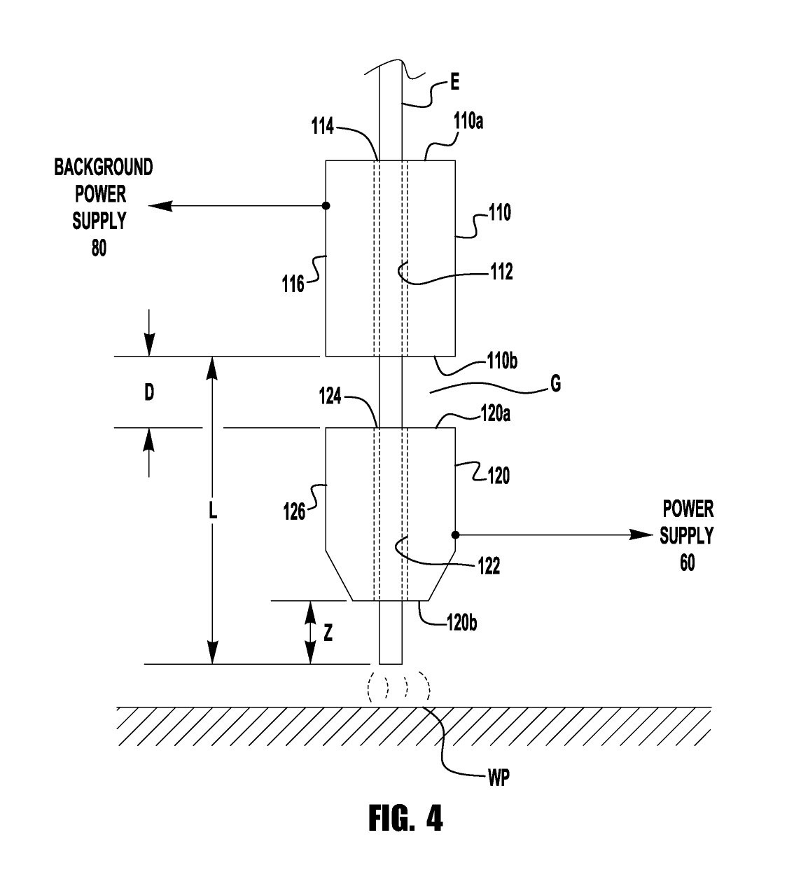

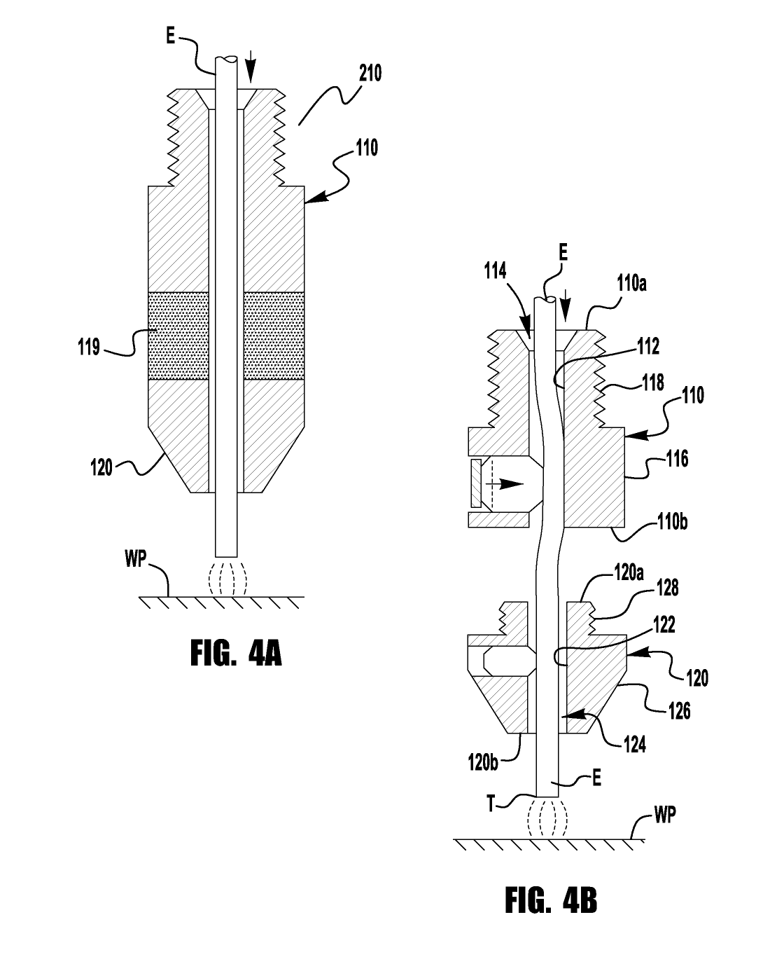

Referring to FIGS. 4, 4A and 4B, shown are illustrative embodiments of the first and second welding contact tip portions 110, 120. FIG. 4 is an illustrative depiction of the contact tip portions 110/120 in the torch 200. It is noted that the remaining structure of the torch 200 is not shown for clarity. As shown, the portions 110 and 120 are in line with each other to allow the electrode E to pass through a channel through each of the portions. Each of the portions 110/120 can be made of a material commonly used for welding contact tips and can be of a general shape and cross-section as commonly used for contact tips. The portions 110/120 are separated from each other by a gap G which electrically isolates them from each other. The upper portion 110 is coupled to the background power supply 80 and the lower portion 120 is coupled to the power supply 60. The first contact tip portion 110 is a member having a proximal end 110a and a distal end 110b. The first contact tip portion 110 further includes an inner surface 112 defining an internal passageway 114 through which the electrode wire E may pass from proximal to distal end 110a, 110b. The passageway 114 may be substantially circular in cross-section; or alternatively, the inner surface may be configured to define alternative passageway cross-sectional geometries, such as for example, rectangle, triangular or oblong. Moreover, the inner surface 112 may define the internal passageway 114 as having a constant width or diameter along the axial length of the passageway. Alternatively, the passageway 114 may vary in its diameter along its length from the proximal to the distal end 110a, 110b.

The first contact tip member 110 has an outer surface 116 which in one aspect defines a substantially circular surface circumscribed about the passageway 114 such that the first contact tip 110 defines a substantially cylindrical volume. The outer surface 116 may form alternative geometries about the passageway 114 such as for example rectangle, triangular, oblong, etc. such that the portion 110 properly fits into a torch 200. Moreover, the geometry of the outer surface 116 may be constant along the axial length of the first contact tip 110 or may vary along the contact tip length. Disposed adjacent to the proximal end 110a of the first contact tip 110 may be an extension 118 having a different shape than the remainder of the portion 110, where the extension 118 can be configured to secure the first contact tip portion 110 within housing of the welding torch 200. As shown, for example in FIG. 4B, the extension 118 includes an external thread.

Downstream of the first portion 110 (in the electrode travel direction) is the second portion 120. The second contact tip portion 120 has a proximal end 120a and a distal end 120b. The second contact tip portion 120 further includes an inner surface 122 defining a second internal passageway 124 through which the electrode wire E may pass from proximal to distal end 120a, 120b. The passageway 124 may be substantially circular in cross-section; or alternatively, the inner surface may be configured to define alternative passageway cross-sectional geometries, such as for example, rectangle, triangular or oblong. Moreover, the inner surface 122 may define a passageway 124 having a constant width or diameter along the axial length of the passageway. Alternatively, the passageway 124 may vary in its diameter along its length from the proximal to the distal end 120a, 120b.

The second contact tip portion 120 has an outer surface 126 which in one aspect defines a substantially circular surface circumscribed about the passageway 124 such that the second contact tip 120 defines a substantially cylindrical volume. The outer surface 126 may form alternative geometries about the passageway 124 such as for example, rectangle, triangular, oblong, etc. such that the portion 120 properly fits into a torch 200. Moreover, the geometry of the outer surface 126 may be constant along the axial length of the second contact tip portion 120 or may vary along the contact tip length. As shown, the distal portion of the second contact tip 120 tapers narrowly in the distal direction. Also, as shown in FIG. 4B, the proximal end 120a of the second contact tip portion 120 may be adjacent to an extension portion 128. The extension 128 can be configured to secure the second contact tip portion 120 within the welding torch 200. As shown, for example in FIG. 4B, the extension 128 includes an external thread. Thus, as shown, the contact tip portions 110 and 120 are secured in a torch 200 such that they have a fixed relationship to each other during welding and so that they are electrically isolated from each other. In FIGS. 4 and 4B the portions are isolated by an air gap G.

However, as shown in FIG. 4A, in other exemplary embodiments of the present invention, each of the portions 110 and 120 can be secured to each other with a dielectric spacer portion 119 separating the portions so that they remain electrically isolated. In such embodiments, the contact tip assembly 210 can be an integral unit comprising the two portions 110/120 and a dielectric spacer portion 119 such that it can be replaced/installed in the torch as a single unit. In such embodiments, the spacer 119 is made of a material which sufficiently isolates the upper portion 110 from the lower portion 120. Further, the material of the spacer 119 can be such that it bonds to each of the portions 110 and 120 to secure each portion to each other. Each of the contact tip portions 110 and 120 can be electrically coupled to their respective power supplies via electrical connections similar to that used for single tip welding applications, which are generally known. For example, each of the contact portions 110/120 can be electrically coupled to the respective power supplies, through the wire feeder 38 which will have separate current paths through a wire feeding conduit (not shown). Alternatively, the power supplies can be separately coupled to the contact tip portions 110/120 via an electrical connection which adequately delivers the appropriate currents. It should also be noted that in exemplary embodiments of the present invention, each of the respective power sources 60 and 80 should contain diode protection in its welding circuits to prevent stray currents from entering the power supplies. Such diode protection circuits are generally known and need not be described in detail herein.

The axial distance D between the first and second contact portions, in one particular aspect, is measured from the distal end 110b of the first contact tip portion 110 to the proximal end 120a of the second contact tip portion 120. The axial distance D is to be a distance to ensure that no current transfer can occur between the upper and lower portions 110/120 during welding. In an exemplary embodiment of the present invention, the distance D ranges from 0.25 to 2 inches. Generally, the overall length of each of the portions is to be decided based on relevant structural and design criteria, but each portion length should be such that sufficient contact is made with the electrode E as it passes through the portions 110/120 so that proper current transfer can occur.

Because each of the contact tip portions 110/120 are electrically isolated from each other each of the portions 110/120 will have a different “stick out” length for their respective currents being provided to the arc. That is, the background current from the power supply 80 will have a first stick out length L (from end 110b to the workpiece WP) and the current from the power supply 60 will have a second stick out length Z (from end 120b to the workpiece WP) which is less than the background current stick out length. The advantages of these varying stick out lengths will be discussed further below.

In exemplary embodiments of the present invention, the first stick out length L is in the range of 1 to 4 inches. Further, in exemplary embodiments of the present invention, the second stick out length Z is in the range of 0.5 to 0.75″. Of course, other ranges can be utilized without departing from the spirit or scope of the present invention depending on the desired welding performance and welding application. It is generally known that because of stick out, the electrode E is heated via the equation I²R. Thus, the longer the stick out the higher the heating of the electrode E—which can be beneficial. However, efforts to increase stick out length can cause issues with welding stability, as the electrode E can wobble or whip around during welding. However, with embodiments of the present invention, the upper portion 110 can have a very long stick out—thus providing increased heating) where the lower portion 120 then acts as a guide to control the electrode E during welding.

In exemplary embodiments of the present invention, the first and second contact tips 110, 120 define a total axial length, as measured from the proximal end 110a of the first contact tip to the distal end 120b of the second contact tip to range from 1.5 to 3.5 inches such that the assembly can be disposed within a known or standard housing of a welding torch or gun.

Referring again to FIG. 3, the first and second contact tip portions 110, 120 are shown secured within the housing 102 at a desired axial distance so as to electrically axially isolate the contact tips 110, 120 from one another. As previously described, the contact tip portions 110, 120 may alternatively be separated and spaced from one another by an insulating or non-conductive material which electrically isolates the first contact tip 110 from the second contact tip 120. To secure the positions of the welding contact tips, the particular embodiment of the welding gun 200 includes a first mounting head 130 engaged with the first contact tip 110 and a second mounting head 140 engaged with the second contact tip 120. The mounting heads 130, 140 includes a central passage 132, 142 for communication with the inner passageways 114, 124 of the contact tip portions 110, 120. Accordingly, shielding gas and/or electrode wire E fed to the torch 200 can continuously fed from the passageways 132, 142 of the mounting heads to the inner passageways 114, 124 of the contact tips 110, 120. Of course, the shielding gas can be delivered via other structural passages without departing from the spirit or scope of the present invention. The mounting heads 130, 140 are also formed with threaded receivers 134, 144 for respectively engaging the threaded extensions 118, 128 of the contact tips 110, 120. The mounting heads 130, 140 may be configured as a known standard component shown and described, for example, in U.S. Pat. No. 7,262,386, which is incorporated herein by reference in its entirety. Accordingly, the mounting heads 130, 140 together with the contact tips 110, 120 may define axially spaced cylindrical surfaces which further define within the interior of the welding gun housing, one or more annular shielding gas passages through which the shielding gas may flow and exit distally to shield the welding arc during the welding process.

In order to selectively apply one or more segments of the welding waveform to the first and second contact tip portions and the welding wire electrode E, the contact tip portions 110/120 are each, respectively, coupled to the power supplies 60/80 as described above. Still referring to FIG. 3, the welding torch 200 further includes a first power sleeve 150 engaged with the first mounting head 130 and a second power sleeve 160 engaged with the second mounting head 140. In one particular embodiment, the power sleeves 150, 160 are substantially annular members each having a central bore in which the mounting heads 130, 140 are secured. Each of power sleeves 140, 150 are secured to the interior surface of an insulating sleeve 170 disposed along the inner surface of the housing 102 of the welding torch 100. The power sleeves 140, 150 are axially spaced within the insulating sleeve 170 so as to define or correspond to the desired axial spacing between the contact tip portions 110, 120 and ensure that each of the portions 110/120 remain electrically isolated from each other.

One or more segments of the welding waveform signal selectively applied to the contact tips 110, 120 through the power sleeves 150, 160, which are each, respectively, coupled to the power supplies 80 and 60 by appropriate leads.

Because the delivery of the welding waveform may be selectively applied to the contact tips 110, 120 and therefore selectively applied to the electrode wire E at different stick out lengths, the overall heat input from the welding waveform into the electrode wire E can be controlled and more efficiently used. That is, because different portions of the waveform can be provided at different stick-out lengths, the welding operation has greater flexibility in controlling stability and heat input, which will be further explained below. For example, lower current may be used in a stable manner over selected portions of the welding process. Moreover, faster pulsed and fast responsive power sources may be used in delivery of welding waveforms due to the selective application of the pulsed waveform at relatively short stick out lengths.

Furthermore, the fact that the background current is being provided at a longer stick out length can reduce the amount of current needed for the pulses to provide proper transfer of the electrode E to the weld puddle. Specifically, because of the length of the stick out for the background current there will be additional heating of the electrode E as the current passes through the length of the electrode E. Because of this additional heating less energy will be needed by the pulses to provide sufficient droplet transfer during welding. That is, less overall power will be needed to provide the melting and transfer of the electrode E during welding. For example, for a particular MIG welding operation it may be needed to have a peak current of 350 amps for each of the pulses and a background current of 50 amps to provide an effective welding operation. With embodiments of the present invention, the pulse peak current can be reduced (to 300 amps, for example) while still obtaining the desired droplet transfer, and the background current can be dropped (for example, from 20 to 10 amps) and still maintain a stable arc during the background. Thus, the overall effect is that a weld can be achieved with significantly less overall heat input into the weld joint, which is desirable for various known reasons. For example, when a low background current is maintained the frequency of the welding waveform can be increased. This results in an increase of the focus of the welding arc. With this, the weld puddle becomes form controlled and the molten droplets from the electrode E are more easily delivered to the desired location (that is, the droplets go where they are pointed). This can provide optimal welding when welding vertical up, and other out-of-position welding applications. Further, when welding at lower wire feed speeds the use of lower background currents provide for an increased range of operating frequencies. That is, when welding with a lower wire feed speed with embodiments of the present invention the welding frequencies can be increased. Furthermore, lower wire feed speeds can be attained because of the higher attainable frequencies. Additional embodiments can provide advantages at high wire feed speed welding applications, for example those that go from axial spray transfer to rotational spray transfer at high wire feed speeds. By forcing more current through the upper portion 110 (that is—a high background current level) the overall current used for welding can be reduced (when compared to prior systems) because of the longer stick out of the background current. As such, embodiments of the present invention can be the overall current below a level which would otherwise case rotational spray transfer and keeping the welding process in a stable axial spray transfer mode.

Referring again to FIG. 3, in other exemplary embodiments of the present invention, the gun 200 has a structure/mechanism which allows the gap G between the contact tip portions 110 and 120 to be adjustable. That is, the structure of the torch 200 can have a rotatable member (not shown) which, when rotated, alters distance between the portions 110/120 while keeping the portions 110/120 axially aligned. This allows a user to manually adjust the distance between the portions 110/120 to achieve a desired stick out distance for the upper portion 110.

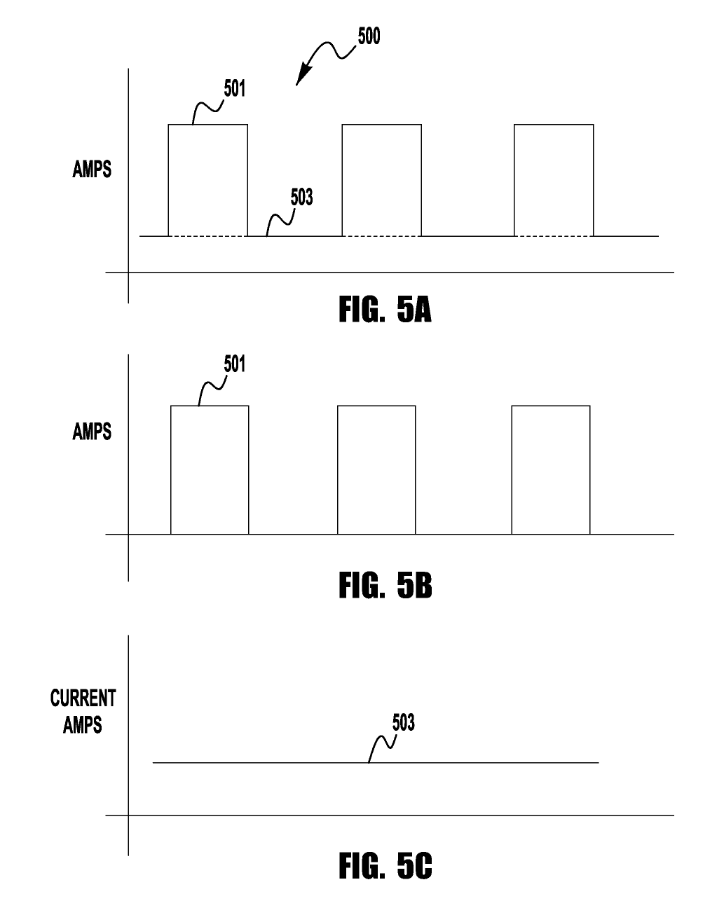

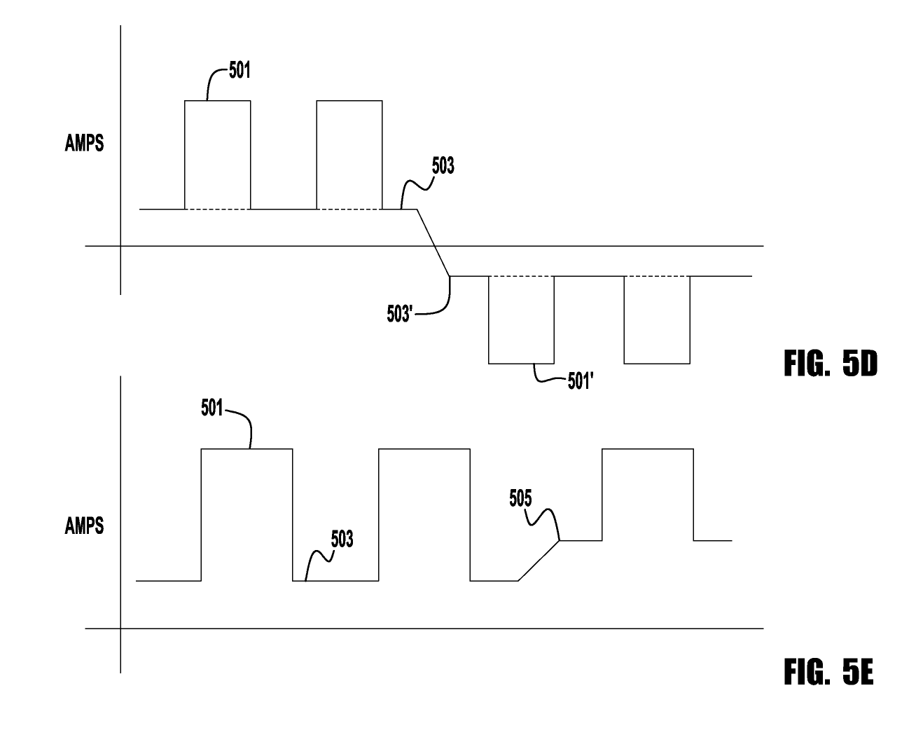

Turning now to FIGS. 5A through 5E, various exemplary waveforms and waveform portions are shown. It should be noted that the waveforms shown in FIGS. 5A-5E are very simplistic pulse waveforms and are intended to be exemplary. Embodiments of the present invention are not limited to the express waveforms shown in these figures. As shown in FIG. 5A, a waveform 500 is shown which is the waveform providing the welding arc. As in typical pulse welding operations, the waveform 500 has a plurality of pulses 501 and a background portion 503 between the pulses 501. Typically, molten droplets of the electrode E are transferred during the pulses, where the overall current is the highest and the arc is maintained during the background portion 503. The waveform 500 represents an exemplary waveform that can be created by embodiments of the present invention.

FIG. 5B depicts the pulses 501 of the waveform 500 which are emitted by the power supply 60 and provided to the electrode E through the contact tip portion 120. As shown in this embodiment, the current pulses 501 are emitted by the power supply 60 such that no background current is provided between the pulses. That is, the power supply 60 only emits current pulses 501 and emits no current between the pulses. Of course, in other exemplary embodiments, the power supply 60 can emit some current between the pulses 501. FIG. 5C depicts the background current 503 that is emitted by the power supply 80 during welding. In the embodiment shown, this current 503 is the background current 503 as shown in FIG. 5A. Thus, during welding the pulses 501 and the background current 503 are combined in the electrode E to provide the waveform 500 used for welding. An advantage of this configuration is that the pulses 501 are emitted by a power supply 60 having a low level of inductance, such that the pulses 501 can be emitted with the desired current ramp rates, while the background current 503 is emitted by a power supply 80 having a high level of inductance. This means that at a low current level, the high inductance will aid in keeping the arc (during background) stable at lower current levels than normally utilized. Furthermore, because the background current 503 is being provided with a longer than normal stick-out length, less current will be needed during the background portion because of the additional heating of the electrode E due to its longer stick-out length. As such, embodiments of the present invention allow for significantly lower background currents to be utilized during welding and thus significantly lower heat input into the weld. For example, embodiments of the present invention can utilize background currents in the range of 5 to 20 amps, and in other embodiments the background level can be in the range of 5 to 15 amps.

Therefore, embodiments of the present invention can be utilized to control heat input into a weld. For example, the system controller 70 can be utilized to control the magnitude of the background current 503 and/or pulses 501 to control the heat input into the weld.

Thus, as described above and shown in FIGS. 5A-5C a welding waveform 500 can be constructed with two different current signals from two different power supplies 60/80. Of course, it should be noted the magnitude of the background current should be taken into account when determining the peak magnitude of current to be provided by the power supply 60. Specifically, the background current 503 will be added to the current from the power supply 60 during the pulses such that a total current will be provided. Thus, if the background current 503 is desired to be at 10 amps, and the peak current for the pulses 501 is desired to be at 300 amps, the power supply should provide a peak of approximately 290 amps during the pulses such that the combined current does not exceed a desired amount.

FIG. 5D depicts another exemplary welding waveform where both power supplies 60/80 are capable of providing an alternating current profile. In some welding operations it may be desirable to utilize a welding waveform having two different polarities at different times. In these embodiments, the power supplies 60/80 provide pulses 501 and a background current 503 of a first polarity, and then for a different duration of the welding provide pulses 501′ and a background current 503′ (respectively) of a second polarity.

FIG. 5E depicts yet another exemplary waveform that can be generated with embodiments of the present invention. In such embodiments, the background current can be changed from a first level 505, providing a first heat input into the weld, to a second level 505, to provide a second heat input into the weld. In exemplary embodiments this change can be effected solely by changing the output of the background power supply 80. In other embodiments, this change can be effected by solely the power supply 60 by the addition of a background current output between pulses, and in yet other embodiments the background current change can be a result of changes in the output of both power supplies 60/80. Of course, it should be noted that if rapid changes in the current level are needed it may be desirable to effect those rapid changes with the power supply 60, which has a lower inductance level than the power supply 80.

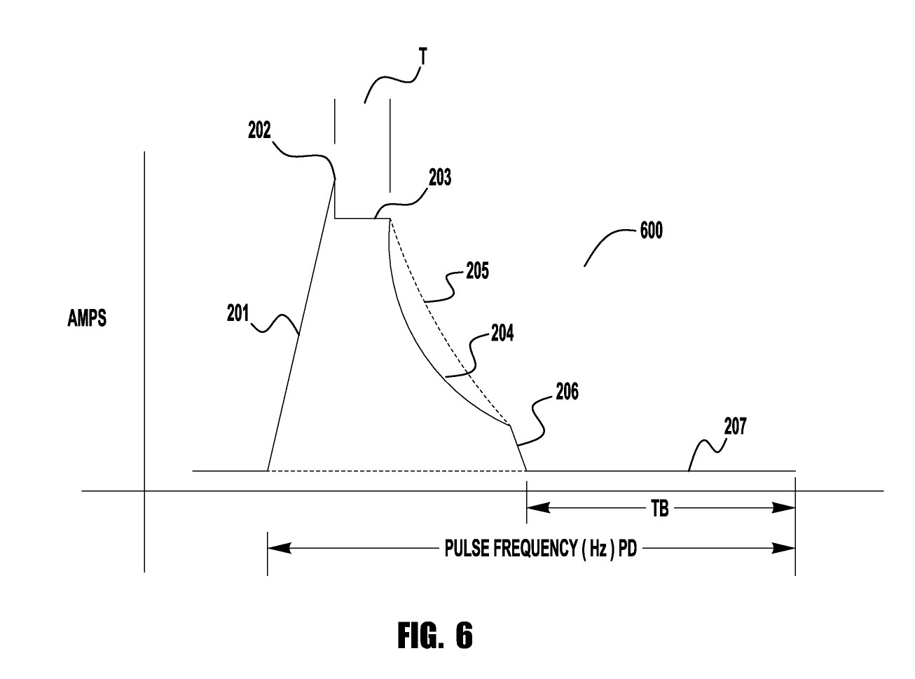

FIG. 6 depicts a single period PD of an exemplary embodiment of a more complex pulsed welding waveform 600 which can be used by the system 100 when welding. The waveform 600 has a number of discrete segments or portions which may be selectively applied to the contact tips 110, 120 and the welding electrode E to provide for a desired weld arc. At the beginning of the pulse is the front flank 201 which defines the ramp-up rate of the waveform over which a molten droplet is formed at the end of the welding electrode E. The level 202 defines an overshoot in the waveform 600, which quantifies the amount of energy required to overcome the influence of inductance in the power source and/or cable length to the power source. The pulse peak current level 203 defines the maximum amplitude of the waveform used in the welding operation which is directly related to the amount of weld penetration. The peak current level 203 is maintained for a duration T, also referred to as the peak current time or peak time. The duration T is directly related to the width of the resultant weld bead. After the peak time T, the waveform 600 includes a tail-out segment 204 which adds energy to the molten droplet during droplet transfer. The tail out speed 205 is directly related to the fluidity of the fluid puddle. A step-off segment 206 reduces the tendency for fine droplet spatter and concludes at the background current segment 207. After reaching the step-off current 206 the current is dropped to a background level 207, which maintains the welding arc for a duration TB. After the time TB, the front flank 201 of the following pulse is begun and the process is repeated. In exemplary embodiments of the present invention, the portions 201-206 are emitted by the power supply 60 and directed to the contact tip portion 120, while the background 207 is emitted by the power supply 80 and directed to the contact tip portion 110. Thus, all current about the background level 207 is emitted by the power supply 60. As is generally understood, the pulse frequency is determined based on the time from the beginning of the front flank 201 of a pulse to the end of the duration TB or the inverse of the waveform period PD. The frequency of the waveform is inversely related to the width of the arc cone of the welding arc. Accordingly, increasing the frequency narrows the arc cone and decreasing the frequency broadens the arc cone. Further, as frequency can control the droplet size, as the frequency increases (with the same wire feed speed) the droplet size decreases. Alternative pulsed welding waveforms may be applied, for example, those shown and described in U.S. Pat. No. 7,173,214, which is incorporated herein by reference in its entirety.

In one particular embodiment of the subject welding process using the welding system 100, lower current levels are used than those previously employed during the background segment 207 of the welding process by applying a constant current to the electrode through the first welding contact tip portion 110. The remainder of the welding waveform 600 is then applied to the welding electrode wire E through the second welding contact tip 120, and can also have lower welding current levels as described above. More specifically, in exemplary embodiments the background segment 207 is a constant low level current ranging between 1 amp and 20 amps from a constant current generation circuit in the power supply 80. Again, as stated above, to maintain the stability of the low level current of the background segment 207, the constant current circuit has a high inductance, for example, 20 milli henries to maintain an arc at 5 to 20 amps. The larger stick out length defined by the first contact tip portion 110, as compared to that of the distally disposed second welding contact tip portion 120, permits the heat input of the low level constant current of the background segment 207 to be better used over a longer distance and for a longer time to preheat the electrode E over the first stick out length. Preheat of the electrode wire E by the first contact tip portion 110 over the background segment 207 reduces the amount of heat input required by the second contact tip 120 and the remainder of the welding waveform 600 to melt the electrode E in formation of the weld.

Accordingly, as stated above, the non-background portion 201-206 of the pulsed welding waveform 600 is generated by the power supply 60 and applied to the distally disposed second welding contact tip portion 120. Moreover, because the background segment 207 is provided by power supply 80, the power supply 60 need not produce the low level background current segment. The welding system 100 may take advantage of the shorter stick out length defined by the second contact tip portion 120 as compared to the proximally located first contact tip portion 110. Because of the shorter stick out length, the welding system 100 may have a low inductance and be fast in response to better adapt the welding pulse segment 201-206 to maintain the arc in accordance with complex welding waveforms.

Because of the flexibility provided by embodiments of the present invention, a welding system 100 with multiple welding contact tip portions for segmenting and selective application of the welding waveform is advantageous for use in out-of-position pulsed welding.

Referring again to FIG. 3, one or both welding contact tip portions 110, 120 may include spring loading assemblies 180, 182 to define a fixed contact point between the inner surfaces 112, 122 and the welding wire electrode E. Exemplary spring loaded assemblies are shown and described in U.S. Patent Publication No. 2009/0294427 which is incorporated by reference in its entirety, and therefore, need not be described in detail herein. As the electrode wire E moves through the contact tip passageways 114, 124 the spring assemblies 180, 182 forces the wire into contact with the inner surface 112, 122. Thus, there is a fixed and predictable contact point for the electrode in each of the contact tip portions 110/120. These fixed distances provide arc stability and coordinates droplet formation with the pulses of welding waveform signal to optimize and minimize variations in the welding process. Of course, in other exemplary embodiments such structure is not needed in the contact tip portions 110/120.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

We claim:

1. A welding system, comprising:
a welding torch having a contact tip which has an upper portion and a lower portion, where said upper portion and said lower portion are electrically isolated from each other and each of said upper portion and lower portion make contact with the same electrode during a welding operation;
a first power supply coupled to said upper portion which provides a first current waveform to said upper portion during said welding operation; and
a second power supply coupled to said second portion which provides a second current waveform during said welding operation, such that said first and second current waveforms are accumulated in said electrode during welding to provide a welding waveform.

2. The welding system of claim 1, wherein said first current waveform is a background current for said welding operation.

3. The welding system of claim 1, wherein said first current waveform is in the range of 5 to 20 amps.

4. The welding system of claim 1, wherein said second current waveform comprises a plurality of current pulses.

5. The welding system of claim 4, wherein between each of said current pulses said second current waveform has a no current portion.

6. The welding system of claim 1, wherein said first power supply utilizes a first output circuit to output said first current waveform and said second power supply utilizes a second output circuit to output said second current waveform, and wherein said first output circuit has a higher inductance than said second output circuit.

7. The welding system of claim 1, wherein said first power supply utilizes a first output circuit to output said first current waveform, and wherein said first output circuit has an inductance of no greater than 100 milli henries with a saturation current in the range of 20 to 50 amps.

8. The welding system of claim 7, wherein said inductance is in the range of 15 to 80 milli henries.

9. The welding system of claim 1, wherein said upper portion has a stick out length in the range of 1 to 4 inches, and the lower portion has a stick out in the range of 0.5 to 0.75 inches.

10. The welding system of claim 1, wherein a dielectric spacer is provided between said upper and lower portions.

11. The welding system of claim 1, wherein each of said first and second power supplies can change, respectively, a polarity of each of said first and second current waveforms during welding.

12. A method of welding, comprising:
providing a welding torch having a contact tip which has an upper portion and a lower portion, where said upper portion and said lower portion are electrically isolated from each other and each of said upper portion and lower portion;
directing a welding electrode to each of said upper portion and lower portion so that each of said upper and lower portions make electrical contact with said electrode during a welding operation;
providing a first current waveform to said upper portion during said welding operation from a first power supply; and
providing a second current waveform to said lower portion during said welding operation, such that said first and second current waveforms are accumulated in said electrode during welding to provide a welding waveform.

13. The welding method of claim 12, wherein said first current waveform is a background current for said welding operation.

14. The welding method of claim 12, wherein said first current waveform is in the range of 5 to 20 amps.

15. The welding method of claim 12, wherein said second current waveform comprises a plurality of current pulses.

16. The welding method of claim 15, wherein between each of said current pulses said second current waveform has a no current portion.

17. The welding method of claim 12, further comprising utilizing a first output circuit having a first inductance to output said first current waveform and utilizing a second output circuit having a second inductance to output said second current waveform, wherein said first inductance is higher than said second inductance.

18. The welding method of claim 12, utilizing a first output circuit to output said first current waveform, wherein said first output circuit has an inductance of no greater than 100 milli henries with a saturation current in the range of 20 to 50 amps.

19. The welding method of claim 18, wherein said inductance is in the range of 15 to 80 milli henries.

20. The welding method of claim 12, further comprising maintaining a stick out length in the range of 1 to 4 inches for said upper portion, and maintaining a stick out in the range of 0.5 to 0.75 inches for said lower portion.

21. The welding method of claim 12, further comprising changing a polarity of each of said first and second current waveforms during said welding operation.
